(19) United States
(12) Patent Application Publication
(10) Pub. No.: US 2021/0150507 A1
(43) Pub. Date: May 20, 2021

(54) SERVING SYSTEM

(71) Applicant: Toyota Jidosha Kabushiki Kaisha, Toyota-shi Aichi-ken (JP)

(72) Inventors: Makoto Kakuchi, Toyota-shi Aichi-ken (JP); Masashi Takahashi, Nagoya-shi Aichi-ken (JP); Shunji Inoue, Okazaki-shi Aichi-ken (JP); Takumi Hamajima, Osaka-shi Osaka-Fu (JP); Hiroaki Sugiyama, Nagoya-shi Aichi-ken (JP); Nobukatsu Fujishita, Nagoya-shi Aichi-ken (JP); Katsuhiko Takeuchi, Chita-gun Aichi-ken (JP); Tomoya Shimizu, Nagoya-shi Aichi-ken (JP)

(21) Appl. No.: 17/095,171

(22) Filed: Nov. 11, 2020

(30) Foreign Application Priority Data
Nov. 14, 2019 (JP) 2019-206446

(51) Int. Cl. G06Q 20/32; G06Q 30/02; G06Q 50/12; G06Q 20/18; G06Q 30/06

(52) U.S. Cl. CPC G06Q 20/322; G06Q 30/0281; G06Q 30/0601; G06Q 20/18; G06Q 50/12

(57) ABSTRACT

A serving system may comprise an acquiring unit configured to acquire order information from an external terminal, the order information indicating a content of an order inputted to the external terminal by a user; a presenting unit configured to present the content of the order indicated by the acquired order information to a serving entity that is to serve a serving-target article corresponding to the content; and a delivery vehicle configured to deliver the serving-target article corresponding to the presented content of the order to the user, and including a traction mechanism provided with a power source.

### CROSS-REFERENCE TO RELATED APPLICATION

This application claims priority to Japanese Patent Application No. 2019-206446 filed on Nov. 14, 2019, the entire contents of which are incorporated herein by reference.

### TECHNICAL FIELD

The art disclosed herein relates to a serving system configured to serve a serving-target article to a user according to an order by the user.

### BACKGROUND

Japanese Patent Application Publication No. 2007-257219 describes a transportation facility information guide system that provides information in a transportation facility for using transportation means such as an airplane or a train to a user of the transportation facility. The transportation facility information guide system provides information of one or more stores within the transportation facility according to a time period before a boarding time of the user.

### SUMMARY

When the user is already in a waiting line, for example, it is difficult for the user to visit a store of which information has been provided. In view of this, the description herein provides an art configured to deliver a serving-target article to a user in accordance with an order by a user.

A serving system disclosed herein may comprise: an acquiring unit configured to acquire order information from an external terminal, the order information indicating a content of an order inputted to the external terminal by a user; a presenting unit configured to present the content of the order indicated by the acquired order information to a serving entity that is to serve a serving-target article corresponding to the content; and a delivery vehicle configured to deliver the serving-target article corresponding to the presented content of the order to the user, and including a traction mechanism provided with a power source.

According to this configuration, the user may obtain the serving-target article according to the user's order without having have to visit a store being the serving entity. Due to this, the user may obtain the serving-target article even in a situation where the user does not visit the serving entity due to not being able to leave the waiting line, for example.

Details and further improvements on the art disclosed herein will be described in Detailed Description below.

### BRIEF DESCRIPTION OF DRAWINGS

FIG. 1 is a diagram for explaining an overview of a serving system of embodiments.

FIG. 2 is a schematic block diagram of the serving system of the embodiments.

FIG. 3 is a diagram indicated a serving database of a first embodiment.

FIG. 4 is a sequence diagram of processes executed by a serving system of the first embodiment.

FIG. 5 is a diagram indicated a serving database of a second embodiment.

FIG. 6 is a sequence diagram of processes executed by a serving system of the second embodiment.

### DETAILED DESCRIPTION

Technical features described in the present application are listed below.

The user, the serving entity, and the delivery vehicle may be located within a specific facility. In the specific facility, only a vehicle given a permission from the specific facility and including the delivery vehicle may be capable of traveling in a pedestrian area for the user.

For example, in an airport, there are cases in which only a permitted vehicle may travel within a building in which users walk. In such a specific facility, the user normally may not move by using a vehicle. As a result, if the serving entity is located far away, it is difficult for the user to visit the serving entity. According to the above configuration, the user may acquire the serving-target article according to the user's order in such a situation without visiting the serving entity.

A presenting unit may be configured to present, in accordance with the content of the order, the content of the order to at least one specific store among a plurality of stores included in the serving entity. The delivery vehicle may be configured to deliver the serving-target article prepared by the specific store to the user.

According to this configuration, the serving-target article to be served to the user may be selected from among the plurality of stores.

The serving system may further comprise an identification information sending unit configured to send vehicle identification information for identifying the delivery vehicle to the external terminal.

According to this configuration, the user may acquire the vehicle identification information from the external terminal. Due to this, the user may identify the vehicle which delivers the serving-target article to the user.

The serving system may further comprise a location specifying unit configured to specify a location of the user at a time of delivering the serving-target article. The delivery vehicle may be configured to deliver the serving-target article to the specified location of the user.

According to this configuration, even if the user moves to another location after having inputted the order and before receiving the serving-target article, the location of the user may be specified by the delivery vehicle.

The serving entity may be configured capable of serving plural types of serving-target articles. The serving system may further comprise: a schedule acquiring unit configured to acquire schedule information indicating a schedule of the user; a serving-target article specifying unit configured to specify, by using the schedule information, one or more types of serving-target articles that can be served among the plural types of serving-target articles; and a serving-target article information sending unit configured to send information indicating the one or more types of specified serving-target articles to the external terminal for enabling the user to select from among the one or more types of the specified serving-target articles.

According to this configuration, a situation in which the serving-target article may not be received due to the schedule of the user may be avoided.

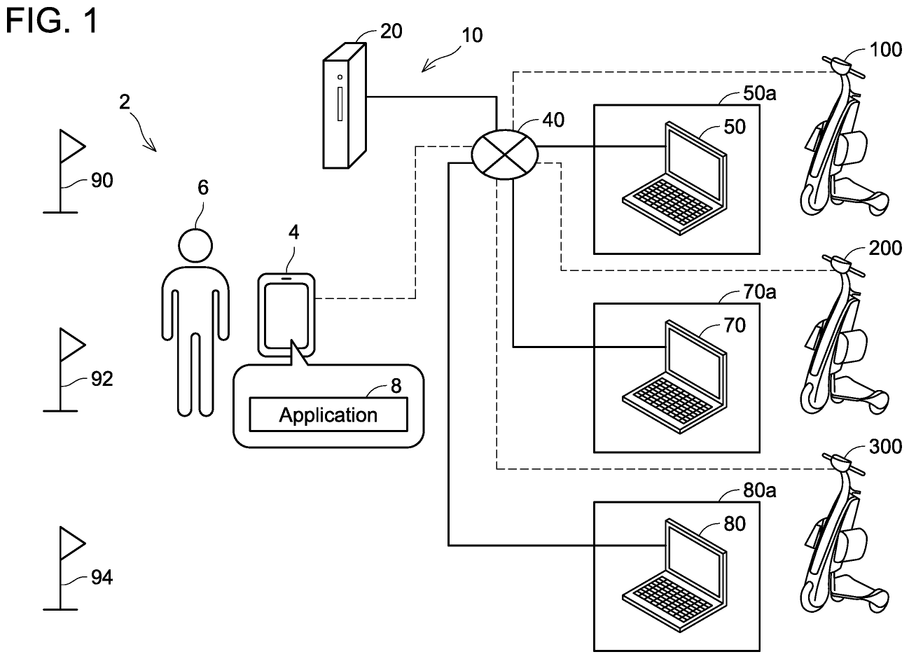

A serving system 10 of embodiments will be described with reference to the drawings. As shown in FIG. 1, the serving system 10 is arranged in a facility 2. The facility 2 may be a transportation facility for using public transportation such as an airport and a station. Alternatively, the facility 2 may be an event facility where sports and exhibitions take place, such as a stadium, a baseball field, and a convention hall, or may be a theme park or a festival site.

In the facility 2, a plurality of users 6 may use the serving system 10 by using their portable terminals 4. Each portable terminal 4 is a device, such as a cell phone, a smartphone, a tablet, and a laptop, that is capable of wirelessly communicating with the serving system 10 through a network 40. In FIG. 1, lines indicating wireless communication are indicated by broken lines and lines indicating wired communication are indicated by solid lines. However, in a variant, the wireless communication and the wired communication are not limited to the above. For example, each of the portable terminals 4 may be a device such as a PC capable of communicating with the serving system 10 by wired communication through the network 40. Each portable terminal 4 has an application 8 for using the serving system 10 installed therein. The application 8 may be provided by an administrator of the serving system 10, such as by the facility 2.

The application 8 includes information for communicably connecting the portable terminal 4 to the serving system 10. The user 6 causes the portable terminal 4 to communicably connect to the serving system 10 by activating the application 8. By doing so, the user 6 can use the serving system 10 by operating the portable terminal 4.

(Configuration of Serving System 10)

The serving system 10 is provided with a server 20, the network 40, a plurality of store-side terminals 50, 70, 80, a plurality of electric vehicles 100, 200, 300, and a plurality of detectors 90, 92, 94. Numbers of the store-side terminals 50, 70, 80 and the electric vehicles 100, 200, 300 are not limited, and for example, there may be one each of the store-side terminal and the electric vehicle, and further, the numbers of the store-side terminals 50, 70, 80 and the electric vehicles 100, 200, 300 may be different from each other.

(Configuration of Server 20)

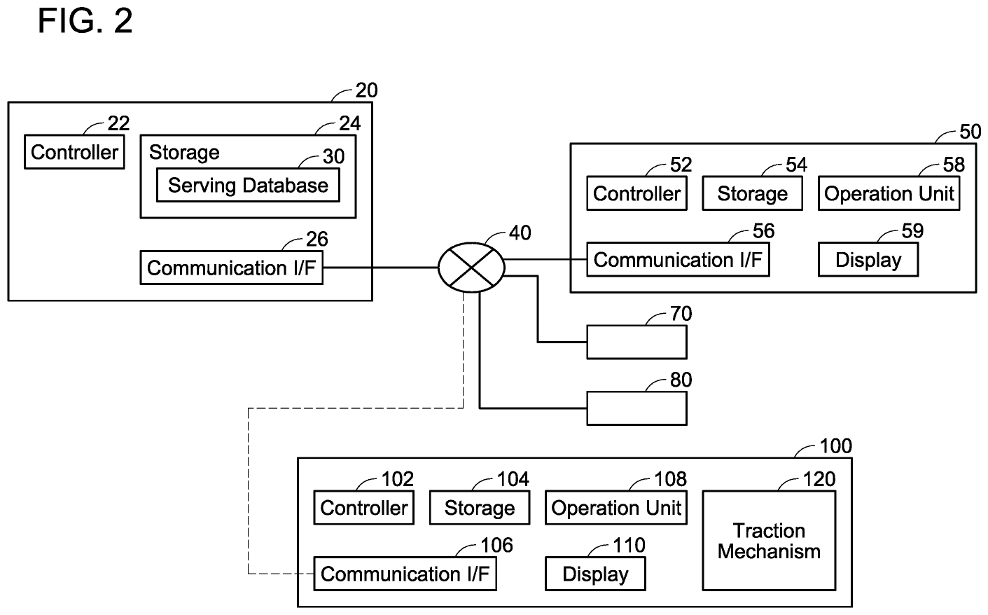

The server 20 is communicably connected to the network 40. As shown in FIG. 2, the server 20 is provided with a controller 22, a storage 24, and a communication interface (an “interface” is denoted as “I/F” in the drawings) 26.

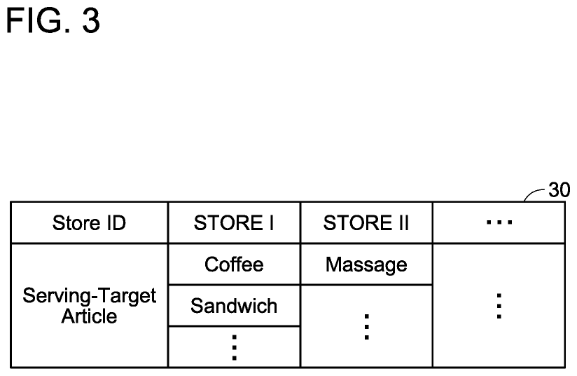

The storage 24 is provided with a hard disk drive and has a large capacity storage area. The storage 24 stores a serving database 30 therein in advance. As shown in FIG. 3, the serving database 30 records identification information (such as IP addresses) for the server 20 to communicate with the store-side terminals 50, 70, 80 through the network 40 and serving-target articles, such as products and services provided by stores where the store-side terminals 50, 70, 80 are installed, in association with each other. The serving database 30 is stored in the storage 24 in advance by the administrator of the serving system 10. Further, the administrator of the serving system 10 updates the serving database 30 by using the server 20 in cases where types of stores or serving-target articles in the facility 2 increase or decrease.

As shown in FIG. 2, the communication interface 26 is provided with, for example, a LAN (Local Area Network) interface for the server 20 to communicate with the network 40. The communication interface 26 may be an interface for wireless communication and/or an interface for wired communication.

The controller 22 includes a CPU and a memory such as RAM and ROM. The controller 22 is connected respectively to the storage 24 and the communication interface 26 by wirings that are not shown in a manner capable of controlling them. The controller 22 stores in its memory a computer program for controlling the storage 24 and the communication interface 26. The controller 22 is configured to execute various types of processes as described later by using the CPU and the memory.

(Configurations of Store-Side Terminals 50, 70, 80)

Each of the store-side terminals 50, 70, 80 is communicably connected to the network 40. The store-side terminal 50 is a terminal installed in a store 50a that operates business in the facility 2. The store-side terminal 50 is for example a communication device such as a PC or a tablet. Stores 50a, 70a, 80a are stores in the facility 2 to which a user of the facility 2 can visit and be served with a serving-target article such as a product or a service. In a variant, at least one of the stores 50a, 70a, 80a may be a store that does not accept visits of the users of the facility 2 and is dedicated to delivering the serving-target articles to the users.

The store-side terminal 50 is provided with a controller 52, a storage 54, a communication interface 56, an operation unit 58, and a display 59. The store-side terminals 70, 80 have similar configurations as that of the store-side terminal 50, thus descriptions thereof will be omitted.

The storage 54 is provided with a hard disk drive, etc., and has a large capacity storage area. The storage 54 stores data required for processes which the store-side terminal 50 executes. The communication interface 56 is provided with a LAN interface, for example, for enabling the store-side terminal 50 to communicate with the network 40. The communication interface 56 may be an interface for wireless communication and/or may be an interface for wired communication.

The operation unit 58 comprises a keyboard and a mouse for a user of the store-side terminal 50 to operate the store-side terminal 50. The display 59 includes a liquid crystal panel. The display 59 is configured to be controlled by the controller 52 and display information (such as a content of an order) that should be notified to the user. The display 59 may be a so-called touch panel display that allows operation by the user, and in this case, the operation unit 58 and the display 59 may be configured integrally.

The controller 52 includes a CPU and a memory such as RAM and ROM. The controller 52 is connected to each of the storage 54, the communication interface 56, the operation unit 58, and the display 59 by wirings that are not shown so as to be capable of controlling them. The controller 52 stores computer programs for controlling the storage 54, the communication interface 56, the operation unit 58, and the display 59 in its memory. The controller 52 is configured to execute various processes to be described later by its CPU and memory.

(Configurations of Electric Vehicles 100, 200, 300)

Each of the electric vehicles 100, 200, 300 is communicably connected wirelessly to the network 40. As shown in FIG. 1, the electric vehicles 100, 200, 300 are vehicles on each of which a driver rides in a standing posture. The electric vehicles 100, 200, 300 are respectively associated with the stores 50a, 70a, 80a. Each of the electric vehicles 100, 200, 300 is used for a staff of its associated store 50a, 70a, or 80a to deliver its serving-target article. The staffs can ride on the electric vehicles 100, 200, 300 to travel, and deliver serving-target articles to the user.

As shown in FIG. 2, the electric vehicle 100 is provided with a controller 102, a storage 104, a communication interface 106, an operation unit 108, a display 110, and a traction mechanism 120. The electric vehicles 200, 300 have similar configurations as that of the electric vehicle 100, thus descriptions thereof will be omitted.

The storage 104 is provided with a hard disk drive, etc., and has a large capacity storage area. The storage 104 stores data required for the electric vehicle 100 to travel. The communication interface 106 is provided for example with a wireless LAN communication interface for enabling the electric vehicle 100 to communicate with the network 40.

The display 110 includes a liquid crystal panel. The display 110 is controlled by the controller 102, and is configured to display an image representing information (such as location information of a user to whom a product is to be delivered) that should be notified to the driver of the electric vehicle 100. The operation unit 108 is configured capable of executing a switch operation by the driver for switching images to be displayed on the display 110. The display 110 may be a so-called touch panel display that allows operation by the user, and in this case, the operation unit 108 and the display 110 may be configured integrally.

The controller 102 includes a CPU and a memory such as RAM and ROM. The controller 102 is connected to each of the storage 104, the communication interface 106, the operation unit 108, the display 110, and the traction mechanism 120 by wirings that are not shown so as to be capable of controlling them. The controller 102 stores computer programs for controlling the storage 104, the communication interface 106, the operation unit 108, the display 110, and the traction mechanism 120 in its memory. The controller 102 is configured to execute various processes to be described later by its CPU and memory.

The traction mechanism 120 includes a motor, a battery, wheels, a handle, an accelerator pedal, a brake pedal, etc. for the electric vehicle 100 to travel. In the traction mechanism 120, the wheels are driven by the motor rotated by power from the battery. The driver can control the electric vehicle 100 to travel by operating the handle, the accelerator pedal, the brake pedal, etc. The driver operates the electric vehicle 100 in the standing posture while holding the handle. The electric vehicle 100 is not provided with a seat. Due to this, the electric vehicle 100 is made compact. Due to this, the electric vehicle 100 can run in a pedestrian area where users of the facility 2 walks without being a hindrance to pedestrians. On the other hand, the electric vehicle 100 is provided with a carrier for placing products.

The plurality of detectors 90, 92, 94 is arranged separated from each other within the facility 2. The plurality of detectors 90, 92, 94 is connected communicably to the server 20. The detectors 90, 92, 94 are configured to specify a location of the portable terminal 4 in which the application 8 is installed by using beacons, for example, and send the same to the server 20.

(Process of Serving System 10)

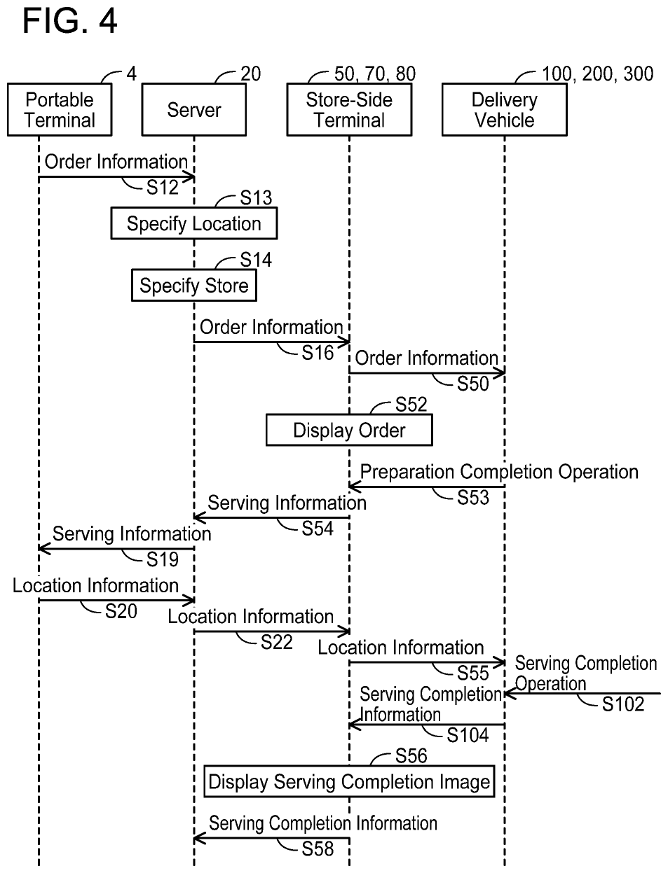

Next, the processes executed by the serving system 10 will be described with reference to FIG. 4. In the processes executed by the serving system 10, a user 6 can be served with serving-target articles such as products and services from the stores 50a, 70a, 80a without visiting the stores 50a, 70a, 80a in the facility 2. The user 6 activates the application 8 installed in the portable terminal 4 of the user 6. The application 8 displays a list of products and services that can be served in the facility 2 on the display of the portable terminal 4. The application 8 has the list of products, etc. that can be served in the facility 2 registered therein in advance.

The user 6 selects a desired serving-target article from the list displayed on the portable terminal 4. Due to this, an order (such as a coffee, massage) is inputted to the portable terminal 4 by the user 6. When the order is inputted, the portable terminal 4 sends order information including a content of the order, identification information of the portable terminal 4 (such as a phone number of the portable terminal 4) to the server 20.

The controller 22 of the server 20 receives the order information sent from the portable terminal 4 (S12). Then, in S13, the controller 22 specifies a current location of the portable terminal 4 by using the identification information of the portable terminal 4 included in the order information. Specifically, the controller 22 sends the identification information of the portable terminal 4 to the plurality of detectors 90, 92, 94. The detectors 90, 92, 94 emit beacons including the identification information of the portable terminal 4. When the beacon from the detector (such as the detector 90) located closest to the portable terminal 4 is received according to the application 8, the portable terminal 4 responds by a response signal to the detector 90 being a sender of the beacon in a case where the identification information of the portable terminal 4 is included in the received beacon. The detector 90 having received the response signal sends the server 20 location information indicating that the response signal was received from the portable terminal 4. The controller 22 specifies the location of the portable terminal 4 by specifying the location of the detector 90 having sent the location information.

Next, in S14, the controller 22 specifies a store that is to serve the product or service. Specifically, the controller 22 specifies, in association with the content of the order included in the order information, identification information of the store associated in the serving database 30. In a variant, same product or service may be provided in a plurality of stores. In this case, the serving database 30 may have registered therein location information indicating a location of each store in association with the identification information of the store. In a case where a plurality of identification information of a plurality of stores registered in association with the content of the order is specified, the controller 22 may specify the identification information of the store recorded in association with location information indicating a closest location to the location of the portable terminal 4 among the plurality of identification information of the plurality of stores.

Next, in S16, the controller 22 sends a combination of the order information, the location information, and the identification information of the portable terminal 4 to a store-side terminal (such as the store-side terminal 50) of the store specified in S14 (such as the store 50a). Hereinbelow, a case will be described in which the combination of the order information, the location information, and the identification information of the portable terminal 4 is sent to the store-side terminal 50, however, the same applies to cases in which such a combination is sent to the store-side terminals 70, 80.

When the combination of the order information, the location information, and the identification information of the portable terminal 4 is received, then in S50, the controller 52 of the store-side terminal 50 sends the combination of the order information, the location information, and the identification information of the portable terminal 4 to the electric vehicle 100 associated with the store 50a. Then, in S52, the controller 52 causes the display 59 to display an order content image indicating the content of the order indicated by the received order information. The staff of the store 50a checks the display 59 and prepare the serving-target article corresponding to the content of the order by the user. According to this configuration, the user can notify the store 50a of the content of the order without visiting the store 50a in person. Further, the controller 52 causes the display 59 to display, in addition to the order content image, a preparation completion button to be operated by the staff of the store 50a when preparation for the serving-target article corresponding to the content of the order is completed.

Next, in S53, the controller 52 monitors a preparation completion operation to be performed by the staff of the store 50a. The staff of the store 50a can operate the preparation completion button by operating the operation unit 58. In S53, when the preparation completion button is operated, the controller 52 determines that the preparation completion operation has been performed. Then, in S54, the controller 52 sends serving information to the server 20. The serving information includes completion information indicating that the serving preparation has been completed, identification information (such as a vehicle number) of the electric vehicle 100 that is to deliver the serving-target article, and the identification information of the portable terminal 4 being the sender of the order information.

When the serving information is received, the controller 22 of the server 20 sends the serving information in S19 to the portable terminal 4 by using the identification information of the portable terminal 4 included in the serving information. When the serving information is received, the portable terminal 4 causes the display to display an image indicating that the serving-target article will soon be delivered and an image indicating the identification information of the electric vehicle 100 according to the application 8. Due to this, the user can acknowledge the identification information of the electric vehicle 100 that is to deliver the serving-target article. As a result, the user can be prevented from acquiring the serving-target article that does not correspond to the content of his/her own order from a different electric vehicle.

Then, in S20, the controller 22 acquires the location information indicating the location of the portable terminal 4 similar to S13. Then, in S22, the controller 22 sends the location information acquired in S20 to the store-side terminal 50.

When the location information is received, the controller 52 of the store-side terminal 50 sends the location information to the electric vehicle 100 in S55. When the location information is received, the controller 102 of the electric vehicle 100 displays the location indicated by the location information on the display 110. Due to this, a staff that is delivering the serving-target article to the user using the electric vehicle 100 can acknowledge the current location of the user. According to this configuration, even if the user moves to another location after having inputted the order, the user can receive the serving-target article at the destination location.

The staff delivering the serving-target article performs a serving completion operation on the operation unit 108 of the electric vehicle 100 after having served the serving-target article to the user. The serving completion operation includes, for example, an operation to press a specific button arranged in the operation unit 108. When the serving completion operation is performed in S102, the controller 102 sends serving completion information in S104 indicating that the serving of the serving-target article has been completed to the store-side terminal 50.

When the serving completion information is received, the controller 52 of the store-side terminal 50 causes the display 59 to display an image in S56 indicating that the serving has been completed. Due to this, the staff of the store 50a can acknowledge that the serving-target article has been safely delivered to the user. Then, in S58, the controller 52 sends the serving completion information to the server 20.

The user can use the serving system 10 to receive the serving-target article from the stores 50a, 70a, 80a without having have to visit the stores 50a, 70a, 80a. According to this configuration, the user can receive the serving-target article in a situation where the user is restricted from moving around such as when the user is waiting in line. Especially when the facility 2 is a transportation facility such as an airport or a station, the user needs to wait in line over a long period of time for receiving a boarding ticket and baggage check-in, in which case the user is restricted from moving around. In such a situation, if, for example, the user wishes to buy food and drink, the user can use the serving system 10 and receive the food and drink without losing his/her position in the line.

### Second Embodiment

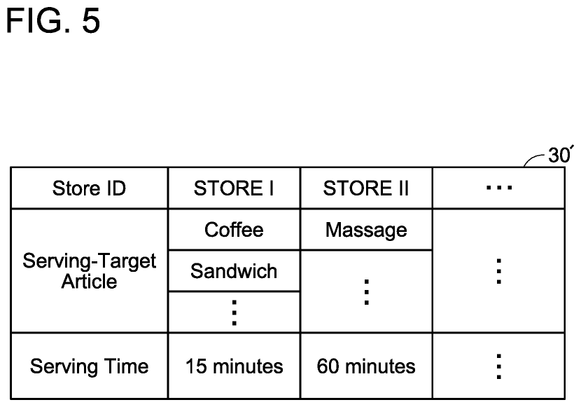

Differences from the first embodiment will be described. In the present embodiment, the serving system 10 limits products, etc. that can be served in accordance with a schedule of the user of the facility 2. Specifically, as shown in FIG. 5, a serving database 30′ stored in the server 20 records therein the identification information of the store-side terminals 50, 70, 80, products or services provided in stores in which the store-side terminals 50, 70, 80 are installed, and a required time required for serving from when an order is received in association with each other.

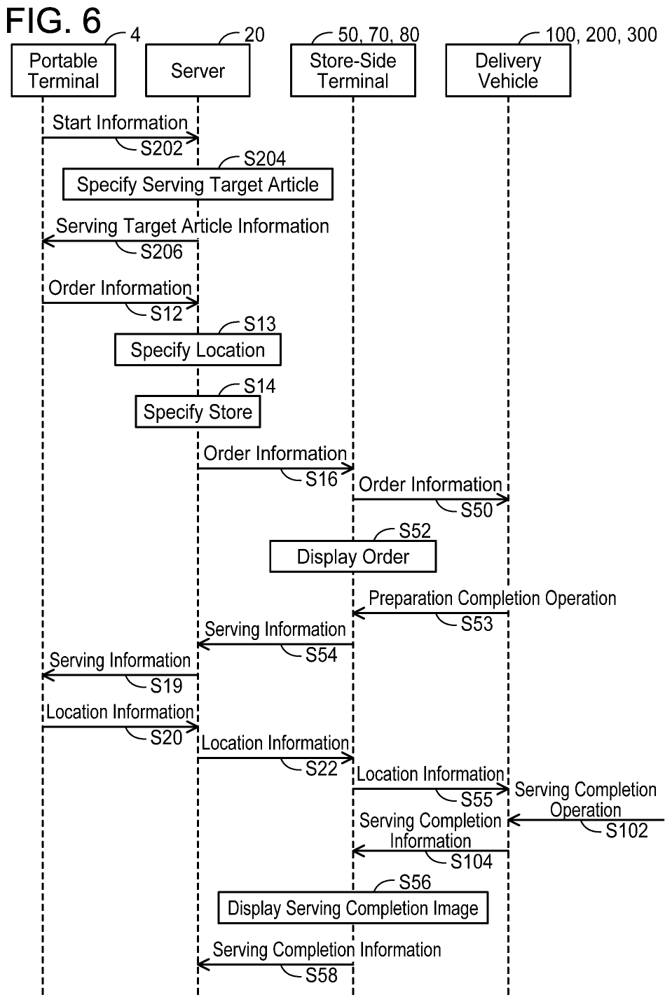

As shown in FIG. 6, in the process executed by the serving system 10, when the user activates the application 8 installed in the portable terminal 4, an image for causing the user to input the schedule is displayed. For example, in the case where the facility 2 is the airport, the portable terminal 4 causes the user to input a boarding time of an airplane to which the user is to board in accordance with the application 8. Further, alternatively, in a case where the facility 2 is an event facility, the portable terminal 4 causes the user to input a starting time of an event in which the user is to participate in accordance with the application 8. When the schedule is inputted, the portable terminal 4 sends schedule information indicating the inputted schedule and start information indicating that the user is to start an order to the server 20 in accordance with the application 8.

When the start information is received (S202), the controller 22 of the server 20 specifies one or more types of serving-target articles, such as a product with the required time recorded in the serving database 230 being shorter than a time period from a current time to the schedule indicated by the schedule information in S204. For example, in a case where the time period from the current time to the schedule is 45 minutes, coffee and sandwich are specified but massage is not specified in the serving database of FIG. 3. Then, in S206, the controller 22 sends serving-target article information indicating the selected products to the portable terminal 4. When the product information is received, the portable terminal 4 causes the display to display the product information as a list of products that can be served n the facility 2. The user selects an order for a desired product or service from the list displayed on the portable terminal 4. Processes after this are similar to the processes executed in the first embodiment.

While specific examples of the present disclosure have been described above in detail, these examples are merely illustrative and place no limitation on the scope of the patent claims. The technology described in the patent claims also encompasses various changes and modifications to the specific examples described above.

(Variants)

(1) In the above embodiments, one electric vehicle 100 is associated with one store 50a. However, a plurality of electric vehicles may be associated with one store 50a. In this case, in S55 of FIG. 4, the controller 52 of the store-side terminal 50 may send the location information to one electric vehicle used for delivering the serving-target article from among the plurality of electric vehicles.

(2) In each of the above embodiments, the plurality of stores 50a, 70a, 80a is in the facility 2. However, the store in the facility 2 may only be one store 50a. In this case, the server 20 may not be provided, and the store-side terminals 50, 70, 80 may execute the processes instead of the server 20. Further, alternatively, only one or more of the store(s) 50a among the plurality of stores 50a, 70a, 80a provided in the facility 2 may have the store-side terminals 50, etc. included in the serving system 10.

(3) In each of the above embodiments, the serving system 10 is provided with the server 20. However, the serving system 10 may not be provided with a server independent from the store-side terminals 50, 70, 80. In this case, a terminal among the store-side terminals 50, 70, 80 may function as the server.

(4) In each of the above embodiments, the electric vehicles 100, 200, 300 are associated with the stores 50a, 70a, 80a. However, the stores 50a, 70a, 80a and the electric vehicles 100, 200, 300 may not be associated. In this case, the electric vehicle used for delivering the serving-target article may suitably be selected from one or more electric vehicles by the store-side terminals 50, 70, 80 of the stores 50a, 70a, 80a being the serving entities, the server 20, or the staffs. In this case, the server 20 may acquire vacancy information indicating whether the vehicle is used for delivery from the electric vehicles 100, 200, 300, and may send the acquired vacancy information to the store-side terminals 50, 70, 80.

(5) In each of the above embodiments, the serving system 10 is provided with the electric vehicles 100, 200, 300 having the motor and battery as its delivery vehicles. However, the serving system 10 may be provided with vehicles having traction mechanisms different from the motor, such as automobiles with engines.

(6) The serving system 10 may not have the store-side terminals 50, 70, 80 installed in each of the stores 50a, 70a, 80a. In this case, the electric vehicles 100, 200, 300 may not be associated with the stores 50a, 70a, 80a. The electric vehicles 100, 200, 300 may have serving entities independent from the stores 50a, 70a, 80a instead of the staffs of the stores 50a, 70a, 80a. The electric vehicles 100, 200, 300 may further execute processes similar to those of the store-side terminals 50, 70, 80. In this case, the serving entities of the electric vehicles 100, 200, 300 may acquire the serving-target articles from the stores 50a, 70a, 80a in accordance with the content of the order displayed on the electric vehicles 100, 200, 300, and deliver the same to the user 6. In this case, the serving system 10 may be provided with portable terminals which the serving entities can carry with them instead of the store-side terminals 50, 70, 80.

The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A serving system comprising:
an acquiring unit configured to acquire order information from an external terminal, the order information indicating a content of an order inputted to the external terminal by a user;
a presenting unit configured to present the content of the order indicated by the acquired order information to a serving entity that is to serve a serving-target article corresponding to the content; and
a delivery vehicle configured to deliver the serving-target article corresponding to the presented content of the order to the user, and including a traction mechanism provided with a power source.

2. The serving system according to claim 1, wherein
the user, the serving entity, and the delivery vehicle are located within a specific facility, and
in the specific facility, only a vehicle given a permission from the specific facility and including the delivery vehicle is capable of traveling in a pedestrian area for the user.

3. The serving system according to claim 1 wherein
the presenting unit is configured to present, in accordance with the content of the order, the content of the order to at least one specific store among a plurality of stores included in the serving entity, and
the delivery vehicle is configured to deliver the serving-target article prepared by the specific store to the user.

4. The serving system according to claim 1, further comprising an identification information sending unit configured to send vehicle identification information for identifying the delivery vehicle to the external terminal.

5. The serving system according to claim 1, further comprising a location specifying unit configured to specify a location of the user at a time of delivering the serving-target article,
wherein the delivery vehicle is configured to deliver the serving-target article to the specified location of the user.

6. The serving system according to claim 1, wherein
the serving entity is configured capable of serving plural types of serving-target articles, and
the serving system further comprises:
a schedule acquiring unit configured to acquire schedule information indicating a schedule of the user;
a serving-target article specifying unit configured to specify, by using the schedule information, one or more types of serving-target articles that can be served among the plural types of serving-target articles; and
a serving-target article information sending unit configured to send information indicating the one or more types of specified serving-target articles to the external terminal for enabling the user to select from among the one or more types of the specified serving-target articles.
